(19) United States
(12) Patent Application Publication
(10) Pub. No.: US 2015/0111990 A1
(43) Pub. Date: Apr. 23, 2015

(54) COATING COMPOSITION WITH IMPROVED ADHESION TO A SUBSTRATE

(71) Applicant: AXALTA COATING SYSTEMS IP CO., LLC, Wilmington, DE (US)

(72) Inventors: Ayumu Yokoyama, Media, PA (US); Violeta Ilieva Petkovska, Philadelphia, PA (US); Eric C. Houze, Mullica Hill, NJ (US); Rajesh Gopalan Saliya, Wilmington, DE (US)

(73) Assignee: AXALTA COATING SYSTEMS IP CO., LLC, Wilmington, DE (US)

(21) Appl. No.: 14/401,550

(22) PCT Filed: Jan. 29, 2013
(86) PCT No.: PCT/US13/23572

§ 371 Date: Nov. 17, 2014

Related U.S. Application Data
(60) Provisional application No. 61/648,127, filed on May 17, 2012.

(51) Int. Cl. C09D 163/00

(52) U.S. Cl. CPC C09D 163/00
USPC 523/400; 427/386

(57) ABSTRACT

A process for providing a coating with improved adhesion to a substrate is provided. The coating composition comprises an epoxy function polymer, a fully alkylated melamine resin and an amidoamine. The process involves forming a mixture of the film forming components and allowing the mixture to mature before adding an acid catalyst. The result is a layer of the coating composition with a high degree of adhesion to the substrate.

### CROSS-REFERENCE TO RELATED APPLICATIONS

This application is a U.S. National-Stage entry under 35 U.S.C. §371 based on International Application No. PCT/US2013/023572, filed Jan. 29, 2013, which was published under PCT Article 21(2) and which claims priority to U.S. Provisional Application No. 61/648,127, filed May 17, 2012, which are all hereby incorporated in their entirety by reference.

### TECHNICAL FIELD

An exemplary embodiment is directed to a process for forming a layer of a coating composition on a substrate wherein the coating composition comprises a solventborne film forming polymer, an alkylated melamine and an amidoamine

### BACKGROUND

Coating compositions can provide one or more protective layers for an underlying substrate and can also have an aesthetically pleasing appearance. A typical coating finish over a substrate can comprise some or all of the following coating layers: (1) one or more primer layers that provide adhesion and basic protection, and also cover minor surface unevenness of the substrate; (2) one or more colored layers, typically pigmented, that provide most of the protection, durability and color; and (3) one or more clearcoat layers that provide additional durability and improved appearance. A colored topcoat layer can be used in place of the colored layer and clearcoat layer. These coatings can be used on buildings, machinery, sporting equipment, vehicles as automotive original equipment manufacture (OEM) and refinish coatings, or in other coating applications.

Each of the different coating composition layers have a variety of functions that they must perform in order to satisfy the basic requirements of the users. For example, each layer of coating composition must adhere well to the adjacent layer(s). The layers should also provide a durable finish that dries to the touch in a relatively short period of time.

### SUMMARY

An exemplary embodiment is directed to a process for producing a layer of a coating composition on a substrate comprising the steps of forming a first coating mixture, wherein the first coating mixture comprises an epoxy functional polymer and a fully alkylated melamine; adding an amidoamine functional crosslinking component to the first coating mixture to form a second coating mixture; allowing the second coating mixture to mature for about 0.5 to about 60 minutes to form a matured coating mixture; adding an acid catalyst to the matured coating mixture to form the coating composition; applying a layer of the coating composition to the substrate to form an applied layer; and curing the applied layer of the coating composition.

### DETAILED DESCRIPTION

The following detailed description is merely exemplary in nature and is not intended to limit an exemplary embodiment or the application and uses of an exemplary embodiment. Furthermore, there is no intention to be bound by any theory presented in the preceding background or the following detailed description.

The features and advantages of an exemplary embodiment will be more readily understood, by those of ordinary skill in the art, from reading the following detailed description. It is to be appreciated that certain features of an exemplary embodiment, which are, for clarity, described above and below in context of separate embodiments, may also be provided in combination in a single embodiment. Conversely, various features of an exemplary embodiment that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both proceeded by the word “about”. In this manner, slight variations above and below the stated ranges can be used to achieve substantially the same results as values within the ranges. Also, an exemplary embodiment of these ranges is intended as a continuous range including every value between the minimum and maximum values.

As Used Herein:

The term “volatile organic compound”, “VOC”, “volatile organic compounds”, or “VOCs” refers to organic chemical compounds of carbon that can vaporize and enter the atmosphere and participate in atmospheric photochemical reactions. VOCs can be naturally occurring or produced from natural or synthetic materials. Some or all VOCs can be regulated under local, national, regional, or international authorities. VOC can be expressed as weight of VOC on a unit of volume of a product, such as grams per liter (g/l). Amounts of VOC in a coating composition can be determined according to ASTM D3960.

An exemplary embodiment is related to a process of forming a layer of a coating composition on a substrate wherein the coating composition is a solventborne coating composition comprising a film forming binder wherein the film forming binder comprises or consists of an epoxy functional polymer, a fully alkylated melamine, and an amidoamine. The process comprises or consists of the steps forming a first coating mixture, wherein the first coating mixture comprises an epoxy functional polymer and a fully alkylated melamine; adding an amidoamine functional crosslinking component to the first coating mixture to form a second coating mixture; allowing the second coating mixture to mature for about 0.5 to about 60 minutes to form a matured coating mixture; adding an acid catalyst to the matured coating mixture to form the coating composition; applying a layer of the coating composition to the substrate; and curing the applied layer of the coating composition.

An exemplary embodiment is also related to a substrate coated by the above process.

The term “mature” or “maturation period” as used herein represents the time period following the formation of the second coating mixture and before the addition of the acid catalyst. During the maturation period of the coating mixture, stirring of the mixture can continue or, in another embodiment, after the formation of the coating mixture, the stirring can be stopped. In some embodiments, the maturation period can be in the range of from about 0.5 to about 60 minutes. In other embodiments, the maturation period can be from about 1 minute to about 45 minutes, and in further embodiments, can be in the range of from about 2 minutes to about 30 minutes. After the maturation period of the coating mixture, the acid catalyst can be added and the mixture stirred to form the coating composition.

The coating composition is a solventborne coating composition and comprises a film forming binder. The film forming binder comprises or consists of an epoxy functional polymer, a fully alkylated amine and an amidoamine functional crosslinking component. The epoxy functional polymer can be any of those known to those of ordinary skill in the art. Suitable epoxy functional polymers can include epoxy functional polymers such as, for example, epoxy functional (meth)acrylic polymers, epoxy functional polyester polymers, epoxy functional polyurethane polymers, bisphenol/epichlorohydrin polymers or a combination thereof. In general, the epoxy functional polymer can have an epoxy equivalent weight in the range of from about 180 to about 3200. In other embodiments, the epoxy equivalent weight can be in the range of from about 200 to about 1000. Epoxy equivalent weight can be determined by ASTM D1652-11.

The coating composition also contains a fully alkylated melamine. The fully alkylated melamine is essentially unreactive to an isocyanate. To be “essentially unreactive”, a mixture of one or more fully alkylated melamines and a diisocyanate must stay un-gelled for at least about 5 hours from the time of mixing and the viscosity of the mixture remains below about 150% of the initial viscosity for at least about 2 hours from the time of mixing at ambient temperatures such as a temperature in a range of from about 15° C. to about 60° C., wherein the initial viscosity is the viscosity of the mixture measured immediately after the one or more fully alkylated melamines and the diisocyanate are just mixed. The mixture can have a weight ratio of the fully alkylated melamine and the diisocyanate in a range of from about 5:1 to about 1:5. In one example, a melamine can be tested for it reactivity towards a diisocyanate by mixing about 1 weight part of the melamine and about 1 weight part of a diisocyanate, such as 1,6-hexamethylene diisocyanate (HDI) and measuring the viscosity of the mixture at about 0, about 2 and about 5 hour time points after mixing at ambient temperatures. The fully alkylated melamine can be determined as essentially unreactive to a diisocyanate if the mixture is not gelled after about 5 hours and the viscosity at the about 2 hour time point remains less than about 150% of the initial viscosity measured at the about 0 hour time point. Other diisocyanates disclosed in an exemplary embodiment or known to or developed by those skilled in the art can also be suitable for testing an alkylated melamine's reactivity.

Any fully alkylated melamines that are essentially unreactive to a diisocyanate can be suitable. In one example, a suitable fully alkylated melamine can include CYMEL® XW-3106 melamine, commercially available from Cytec Industries, Inc., Wallingford, Conn. The fully alkylated melamine can include fully alkylated melamine aldehyde condensation products or derivatives, such as alkylated melamine formaldehyde. In one example, the fully alkylated melamines that are essentially unreactive to a diisocyanate can include fully alkylated melamines that are essentially free from isocyanate reactive hydrogens, for example, are free from —OH, —NH or —NH₂ groups. The term “essentially free from isocyanate reactive hydrogen” means that the fully alkylated melamine can have minor amounts of functional groups having the isocyanate reactive hydrogen, such as —OH, —NH or —NH₂, and a mixture of the fully alkylated melamine and the polyisocyanate at ambient temperature does not form a gel and the crosslinking component can remain in a low viscosity range suitable for coating applications, such as mixing with a crosslinkable component for spraying, rolling, brushing, dipping, draw-down, or a combination thereof. The fully alkylated melamine can have in a range of from about 0 to about 10 percent in one example, about 0 to about 5 percent in another example, about 0 to about 1 percent in yet another example, about 0 to about 0.1 percent in yet another example, of melamines that have one or more isocyanate reactive hydrogens, wherein the percentages are based on the total weight of melamine in the coating mixture.

The fully alkylated melamine can be formed by methods known in the art. In some embodiments, melamine can first be reacted with an excess of one or more C₁-C₅ aldehydes to form alcohols, and then reacted with one or more C₁-C₁₀ alkylation agents. The fully alkylated melamine can comprise alkylation groups selected from one or more C₁-C₁₀ alkyls in one example, C₁-C₅ alkyls in another example. In a further example, the fully alkylated melamine can comprise methyl groups. In yet another example, the fully alkylated melamine can comprise butyl groups. In yet another example, the fully alkylated melamine can comprise a combination of methyl and butyl groups. A melamine having all amine groups alkylated is referred to as a fully alkylated melamine. Examples of fully alkylated melamine can include hexamethoxymethylmelamine, hexabutoxymethylmelamine and melamine having butoxymethyl groups, ethoxymethyl groups, methoxymethyl groups, or a combination thereof.

The amidoamine functional crosslinking components are known to those of ordinary skill in the art. Suitable amidoamine functional crosslinking components are the reaction product of one or more monocarboxylic acids and/or dicarboxylic acids with one or more diamines and/or polyamines and can have structures according to, for example, the following formulas (I) through (VI);

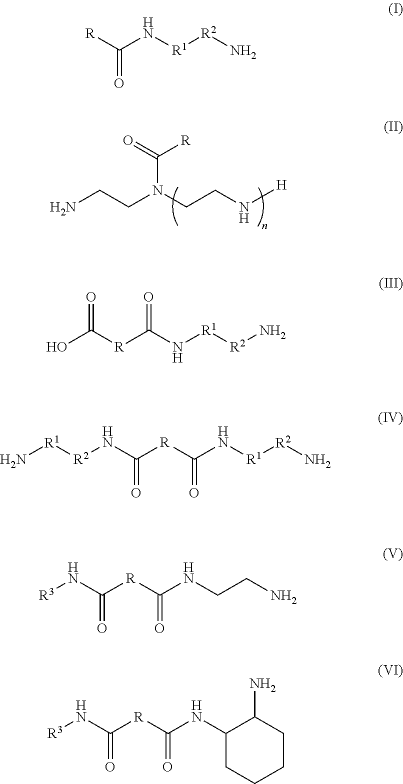

wherein n is 0, 1, 2, 3 or 4 and each R, R¹, R² and R³, independently, are an alkyl or alkylene group having in the range of from 1 to 25 carbon atoms, a cycloalkyl or cycloalkylene group having in the range of from 3 to 9 carbon atoms or wherein R¹ and R² join together to form a cycloaliphatic ring, as in, for example, structure (VI). Monocarboxylic acids that may be used to form the desired amidoamine functional crosslinking component can include, for example, formic acid, acetic acid, propanoic acid, butanoic acid, pentanoic acid, caproic acid, heptanoic acid, caprylic acid, nonanoic acid, capric acid, lauric acid, myristic acid, palmitic acid, stearic acid or a combination thereof. Suitable dicarboxylic acids that can be used can include, for example, malonic acid, succinic acid, methyl succinic acid, glutaric acid, adipic acid, pimelic acid, suberic acid, azelaic acid, sebacic acid, hexahydrophthalic acid, methyl hexahydrophthalic acid or a combination thereof. Anhydrides and/or esters of these acids, where available, may also be used. Suitable diamines and polyamines can include, for example, ethylene diamine, diethylene triamine, trimethylene tetramine, tetraethylene pentamine, tris-(2-aminoethyl)amine, aminoethyl piperazine, pentaethylene hexamine, 1,2-diaminocyclohexane, 1,3-diaminocylcohexane, 1,4-diaminocyclohexane or a combination thereof. The amidoamine functional crosslinking component may further comprise any of the above listed diamines or polyamines as a crosslinking component.

The acid catalyst can be any of those acid catalysts that are common in coating compositions. Suitable acid catalysts can include carboxylic acids, sulfonic acids, phosphoric acids or a combination thereof. In some embodiments, the acid catalyst can include, for example, acetic acid, formic acid, dodecyl benzene sulfonic acid, dinonyl naphthalene sulfonic acid, para-toluene sulfonic acid, phosphoric acid, or a combination thereof.

The coating compositions in an exemplary embodiment comprise conventional coating additives that are commonly used in the art. In some embodiments, the process can further comprise the steps of mixing one or more pigments, one or more solvents, ultraviolet light stabilizers, ultraviolet light absorbers, antioxidants, hindered amine light stabilizers, leveling agents, rheological agents, thickeners, antifoaming agents, wetting agents, or a combination thereof, with the coating mixture or the coating composition. In other embodiments, any one or more of the above listed conventional coating additives can be included with any one or more of the components.

The coating composition is a solventborne coating composition comprising only organic solvent. In other embodiments, the coating composition comprises in the range of from about 50 to about 100 percent by weight of one or more organic solvents, based on the total amount of volatile liquid carrier in the coating composition. In another embodiment, the coating composition can comprise in the range of from about 60 to about 95 percent by weight of organic solvents, and, in still further embodiments, the can comprise in the range of from about 65 to about 90 percent by weight organic solvents, wherein the percentages by weight are based on the total amount of volatile liquid carrier in the coating composition. Examples of organic solvents can include, but not limited to, aromatic hydrocarbons, such as, toluene, xylene, p-chlorobenzotrifluoride; alcohols, such as, propanol, isopropanol, butanol, benzyl alcohol; ketones, such as, acetone, methyl ethyl ketone, methyl isobutyl ketone, methyl amyl ketone and diisobutyl ketone; esters, such as, ethyl acetate, n-butyl acetate, isobutyl acetate, ethers, such as, diethylene glycol, dibutyl ether, dipropylene glycol, methyl ether, ethylene glycol monobutyl ether, tetrhydrofuran; and a combination thereof. If water is present in the coating composition, it is present only in trace amounts (less than 1 percent by weight, based on the total amount of volatile liquid carrier) and, in further embodiments, no water was intentionally added to the coating composition.

The coating composition of an exemplary embodiment can be formulated as a clearcoat or pigmented coating composition. Pigmented coating compositions can be used as a primer, a basecoat, or a topcoat, such as colored topcoat. Conventional inorganic and organic colored pigments, metallic flakes and powders, such as, aluminum flake and aluminum powders; special effects pigments, such as, coated mica flakes, coated aluminum flakes colored pigments, or a combination thereof can be used. Transparent pigments or pigments having the same refractive index as the cured binder can also be used. One example of such transparent pigment can be silica. Other examples of pigments can include, for example, titanium dioxide, barium sulfate, mica, iron oxide, iron hydroxide, calcium carbonate, carbon black, zinc oxide or a combination thereof.

Examples of such ultraviolet light stabilizers can include ultraviolet light absorbers, screeners, quenchers, and hindered amine light stabilizers. An antioxidant can also be added to the coating composition.

Typical ultraviolet light stabilizers that are suitable for an exemplary embodiment can include benzophenones, triazoles, triazines, benzoates, hindered amines and mixtures thereof. A blend of hindered amine light stabilizers, such as TINUVIN® 328 and TINUVIN® 123, all commercially available from BASF, Florham Park, N.J., under respective registered trademark, can be used.

Typical ultraviolet light absorbers that are suitable for an exemplary embodiment can include hydroxyphenyl benzotriazoles, such as, 2-(2-hydroxy-5-methylphenyl)-2H-benzotriazole, 2-(2-hydroxy-3,5-di-tert-amyl-phenyl)-2H-benzotriazole, 2-[2-hydroxy-3,5-di-(1,1-dimethylbenzyl)phenyl]-2H-benzotriazole, reaction product of 2-(2-hydroxy-3-tert-butyl-5-methyl propionate)-2H-benzotriazole and polyethylene ether glycol having a weight average molecular weight of 300, 2-(2-hydroxy-3-tert-butyl-5-iso-octyl propionate)-2H-benzotriazole; hydroxyphenyl s-triazines, such as, 2-[4-((2,-hydroxy-3-dodecyloxy/tridecyloxypropyl)-oxy)-2-hydroxyphenyl]-4,6-bis(2,4-dimethylphenyl)-1,3,5-triazine, 2-[4-(2-hydroxy-3-(2-ethylhexyl)-oxy)-2-hydroxyphenyl]-4,6-bis(2,4-dimethylphenyl)1,3,5-triazine, 2-(4-octyloxy-2-hydroxyphenyl)-4,6-bis(2,4-dimethylphenyl)-1,3,5-triazine; hydroxybenzophenone U.V. absorbers, such as, 2,4-dihydroxybenzophenone, 2-hydroxy-4-octyloxybenzophenone, and 2-hydroxy-4-dodecyloxybenzophenone.

Typical antioxidants that are suitable for an exemplary embodiment can include tetrakis[methylene(3,5-di-tert-butylhydroxy hydrocinnamate)]methane, octadecyl 3,5-di-tert-butyl-4-hydroxyhydrocinnamate, tris(2,4-di-tert-butylphenyl)phosphite, 1,3,5-tris(3,5-di-tert-butyl-4-hydroxybenzyl)-1,3,5-triazine-2,4,6-(1H,3H,5H)-trione and benzenepropanoic acid, 3,5-bis(1,1-dimethyl-ethyl)-4-hydroxy-C7-C9 branched alkyl esters. Typically useful antioxidants can also include hydroperoxide decomposers, such as SANKO® HCA (9,10-dihydro-9-oxa-10-phosphenanthrene-10-oxide), triphenyl phosphate and other organo-phosphorous compounds, such as, IRGAFOS® TNPP from Ciba Specialty Chemicals, IRGAFOS® 168, from Ciba Specialty Chemicals, ULTRANOX® 626 from GE Specialty Chemicals, IRGAFOS® P-EPQ from Ciba Specialty Chemicals, ETHANOX® 398 from Albemarle, Weston 618 from GE Specialty Chemicals, IRGAFOS® 12 from Ciba Specialty Chemicals, IRGAFOS® 38 from Ciba Specialty Chemicals, ULTRANOX® 641 from GE Specialty Chemicals and DOVERPHOS® S-9228 from Dover Chemical, Dover, Ohio.

Typical hindered amine light stabilizers can include N-(1,2,2,6,6-pentamethyl-4-piperidinyl)-2-dodecyl succinimide, N-(1-acetyl-2,2,6,6-tetramethyl-4-piperidinyl)-2-dodecyl succinimide, N-(2-hydroxyethyl)-2,6,6,6-tetramethylpiperidine-4-ol-succinic acid copolymer, 1,3,5-triazine-2,4,6-triamine, N,N′″-[1,2-ethanediybis[[[4,6-bis[butyl(1,2,2,6,6-pentamethyl-4-piperidinyl)amino]-1,3,5-triazine-2-yl]imino]-3,1-propanediyl]]-bis-[N,N′″-dibutyl-N′,N′″-bis-(1,2,2,6,6-pentamethyl-4-piperidinyl)], bis(2,2,6,6-tetramethyl-4-piperidinyl)sebacate, bis(1,2,2,6,6-pentamethyl-4-piperidinyl)sebacate, bis(1-octyloxy-2,2,6,6-tetramethyl-4-piperidinyl)sebacate, bis(1,2,2,6,6-pentamethyl-4-piperidinyl)[3,5-bis(1,1-dimethylethyl-4-hydroxy-phenyl)methyl]butyl propanedioate, 8-acetyl-3-dodecyl-7,7,9,9,-tetramethyl-1,3,8-triazaspiro(4,5)decane-2,4-dione, and dodecyl/tetradecyl-3-(2,2,4,4-tetramethyl-21-oxo-7-oxa-3,20-diaza dispiro(5.1.11.2)henicosan-20-yl)propionate.

The coating compositions of an exemplary embodiment can comprise conventional coating additives. The aforementioned additives or a combination thereof can be suitable. Further examples of such coating additives can include wetting agents, leveling and flow control agents, for example, RESIFLOW®S (acrylic flow control agent), BYK® 320 and 325 (high molecular weight polyacrylates), BYK® 347 (polyether-modified siloxane) under respective registered trademarks, leveling agents based on (meth)acrylic homopolymers; rheological control agents, such as highly disperse silica, or fumed silica; thickeners, such as partially crosslinked polycarboxylic acid or polyurethanes; and antifoaming agents. The additives are used in conventional amounts familiar to those skilled in the art.

The coating composition of an exemplary embodiment can be applied over the substrate using typical coating application methods or process, such as spraying, brushing, dipping, roller coating, drawn down, or a combination thereof, as known to or developed by those skilled in the art. In some embodiments, the substrate can be a vehicle, a vehicle part, or a combination thereof.

The coating composition can be further adjusted to spray viscosity with one or more organic solvents as determined by those skilled in the art before being applied over the substrate.

The applied layer of coating composition can be cured, in some embodiments, at a temperature in a range of from about 10° C. to about 32° C. In another embodiment, the applied layer of coating composition can be cured at a temperature in a range of from about 32° C. to about 82° C.

An exemplary embodiment is also related to a substrate coated by the previously described process. The substrate can be any article or object that can be coated with a coating composition. The substrate can include a vehicle, parts of a vehicle, or a combination thereof. The coating composition according to an exemplary embodiment can be suitable for vehicle and industrial coating and can be applied using known processes. In the context of vehicle coating, the coating composition can be used both for vehicle original equipment manufacturing (OEM) coating and for repairing or refinishing coatings of vehicles and vehicle parts. Curing of the coating composition can be accomplished at temperatures in a range of from about 10° C. to about 82° C.

Examples of coated substrate can include, but not limited to home appliances, such as refrigerators, washing machines, dishwashers, microwave ovens, cooking and baking ovens; electronic appliances, such as television sets, computers, electronic game sets, audio and video equipment; recreational equipment, such as bicycles, ski equipment, all-terrain vehicles; and home or office furniture, such as tables, file cabinets. In one example, the coated substrate is a vehicle or parts of a vehicle.

### EXAMPLES

Unless otherwise specified, all ingredients are available from the Aldrich Chemical Company, Milwaukee, Wis.

CORLAR® 525-885 epoxy and FG-040® amidoamine are available from DuPont, Wilmington, Del.

CYMEL® XW-3106 melamine and CYCAT® 600 acid catalyst are available from Cytec Industries Inc., Woodland Park, N.J.

Dry to touch time is determined according to ASTM D-1640.

Unless otherwise specified, all amounts in Table 1 are in parts by weight.

TABLE 1

| | | | |
|---|---|---|---|
| | Comparative | Comparative | Comparative |
| Coating | Coating | Coating | Coating |
| Example 1 | Example A | Example B | Example C |

Part 1

| | | | | |
|---|---|---|---|---|
| CORLAR ® 525- | 40 | 40 | 40 | 40 |
| 885 epoxy | | | | |
| CYMEL ® XW- | 10 | 0 | 10 | 10 |
| 3106 | | | | |

Part 2

| | | | | |
|---|---|---|---|---|
| FG-040 ® | 20 | 20 | 20 | 20 |
| amidoamine | | | | |
| Induction Time | 30 | 0 | 0 | 0 |
| (minutes) | | | | |

Part 3

| | | | | |
|---|---|---|---|---|
| CYCAT ®600 | 1 | 0 | 0 | 1 |

Results

| | | | | |
|---|---|---|---|---|
| Dry-to-touch | 1 | 1 | 3 | 2 |
| time (hours) | | | | |
| Adhesion rating | 5A | 2A | 3A | 3A |

### Preparation of Coating Example 1

A mixture of CORLAR® 525-885 epoxy and CYMEL® XW-3106 were added to a suitable mixing vessel and stirred to form a coating mixture. FG-040® amidoamine was then added to the coating mixture. This mixture was then stirred for 30 minutes. CYCAT® 600 acid catalyst was then added and stirred to form the coating composition.

### Preparation of Comparative Coating Example a

CORLAR® 525-885 epoxy was added to a suitable mixing vessel and stirred. FG-040® amidoamine was then added to the coating mixture followed by the addition of CYCAT® 600 acid catalyst. The mixture was stirred to form a comparative coating composition.

### Preparation of Comparative Coating Example B

A mixture of CORLAR® 525-885 epoxy and CYMEL® XW-3106 were added to a suitable mixing vessel and stirred to form a coating mixture. FG-040® amidoamine was then added to the coating mixture followed by the addition of CYCAT® 600 acid catalyst.

### Preparation of Comparative Coating Example C

A mixture of CORLAR® 525-885 epoxy and CYMEL® XW-3106 were added to a suitable mixing vessel and stirred to form a coating mixture. FG-040® amidoamine was then added to the coating mixture, followed by the immediate addition of CYCAT® 600 acid catalyst, with stirring, to form the coating composition.

Each of the prepared coating compositions were applied in one 102 micrometer thick coat via a draw down blade to electrocoated cold rolled steel panels available from ACT Panels LLC, Hillsdale, Mich. The panels were then allowed to dry at ambient temperature for 24 hours.

The coated panels were analyzed for the dry-to-touch time and tested for adhesion via ASTM D3359.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of an exemplary embodiment in any way. Rather, the foregoing detailed description will provide those skilled in the art with a convenient road map for implementing an exemplary embodiment, it being understood that various changes may be made in the function and arrangement of elements described in an exemplary embodiment without departing from the scope of an exemplary embodiment as set forth in the appended claims and their legal equivalents.

1. A process for producing a layer of a coating composition on a substrate comprising the steps of:
forming a first coating mixture, wherein the first coating mixture comprises;
an epoxy functional polymer; and
a fully alkylated melamine;
adding an amidoamine functional crosslinking component to the first coating mixture to form a second coating mixture;
allowing the second coating mixture to mature for about 0.5 to about 60 minutes to form a matured coating mixture;
adding an acid catalyst to the matured coating mixture to form the coating composition;
applying a layer of the coating composition to the substrate to form an applied layer; and
curing the applied layer of the coating composition.

2. The process of claim 1 wherein the curing is conducted at a temperature in the range of from about 10° C. to about 32° C.

3. The process of claim 1 wherein the curing is conducted at a temperature in the range of from about 32° C. to about 82° C.

4. The process of claim 1 wherein the fully alkylated melamine is hexamethoxymethylmelamine, hexabutoxymethylmelamine and melamine having butoxymethyl groups, ethoxymethyl groups, methoxymethyl groups, or a combination thereof.

5. The process of claim 1 wherein the amidoamine functional crosslinking component is a reaction product of monocarboxylic acids and/or dicarboxylic acids with diamines and/or polyamines.

6. The process of claim 1 wherein the acid catalyst is acetic acid, formic acid, dodecyl benzene sulfonic acid, dinonyl naphthalene sulfonic acid, para-toluene sulfonic acid, phosphoric acid, or a combination thereof.

7. The process of claim 1 wherein the coating composition is a primer, a basecoat, a colored topcoat or a clearcoat.

8. A substrate coated by a process comprising the steps of:
forming a first coating mixture, wherein the first coating mixture comprises;
an epoxy functional polymer; and
a fully alkylated melamine;
adding an amidoamine functional crosslinking component to the first coating mixture to form a second coating mixture;
allowing the second coating mixture to mature for about 0.5 to about 60 minutes to form a matured coating mixture;
adding an acid catalyst to the matured coating mixture to form the coating composition;
applying a layer of the coating composition to the substrate to form an applied layer; and
curing the applied layer of the coating composition.

9. The substrate of claim 8 wherein the curing is conducted at a temperature in the range of from about 10° C. to about 32° C.

10. The substrate of claim 8 wherein the curing is conducted at a temperature in the range of from about 32° C. to about 82° C.

11. The substrate of claim 8 wherein the fully alkylated melamine is hexamethoxymethylmelamine, hexabutoxymethylmelamine and melamine having butoxymethyl groups, ethoxymethyl groups, methoxymethyl groups, or a combination thereof.

12. The substrate of claim 8 wherein the amidoamine functional crosslinking component is a reaction product of one or more monocarboxylic acids and/or dicarboxylic acids with one or more diamines and/or polyamines.

13. The substrate of claim 8 wherein the acid catalyst is acetic acid, formic acid, dodecyl benzene sulfonic acid, dinonyl naphthalene sulfonic acid, para-toluene sulfonic acid, phosphoric acid, or a combination thereof.

14. The substrate of claim 8 wherein the coating composition is a primer, a basecoat, a colored topcoat or a clearcoat.
